(19) United States
(12) Patent Application Publication
(10) Pub. No.: US 2010/0141059 A1
(43) Pub. Date: Jun. 10, 2010

(54) CAPACITOR MOTOR AND PROCESS FOR PRODUCING THE SAME

(75) Inventor: Shigeki Nishimura, Gifu (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/996,666

(22) PCT Filed: Sep. 15, 2006
(86) PCT No.: PCT/JP2006/318363

§ 371 Date: Jan. 24, 2008

(30) Foreign Application Priority Data
Oct. 24, 2005 (JP) 2005-308178
Nov. 16, 2005 (JP) 2005-331083
Jan. 27, 2006 (JP) 2006-018827

(51) Int. Cl. H02K 1/02; H02K 15/12

(52) U.S. Cl. 310/44; 29/596

(57) ABSTRACT

A capacitor motor is formed of a stator including a stator iron core and windings, and a rotor including a rotor iron core. The stator iron core is divided into a plurality of first divided iron-core units having tooth sections and a second divided iron-core unit forming a magnetic path of the first divided iron-core units. The windings are mounted to the tooth sections and accommodated in a plurality of slots formed by the first iron-core units and the second one. The first divided iron-core units are formed by punching electromagnetic steel plates and layering the plates punched out. The second divided iron-core unit is formed by molding magnetic powder into a given shape. The first divided iron-core units and the second one are jointed together by a given means such that the tooth sections can be arranged radially on outer wall of the rotor iron core.

### TECHNICAL FIELD

The present invention relates to a capacitor motor including a stator iron core and a stator. The stator iron core is separated into pieces, of which quantity is equal to or more than the number of slots, and formed by combining a layered iron-core unit made by punching electromagnetic steel plates and layering the steel plates punched out with a dust core made by forming magnetic powder into a given shape. The present invention also relates to a method of manufacturing the forgoing capacitor motor.

### BACKGROUND ART

A conventional capacitor motor has been formed in the following manner: an armature core (hereinafter referred to as a stator iron core) is divided into plural pieces, and the respective pieces are formed of magnetic powder. Stator teeth (hereinafter referred to as tooth sections) are wound by coils (windings), then the tooth sections are integrated into the armature yokes (yoke sections) arranged in an annular shape. This structure is widely known and disclosed in, e.g. Unexamined Japanese Patent Publication No. H09-215230.

The foregoing conventional motor is detailed hereinafter with reference to FIG. 43, which shows a stator of the forgoing motor. The stator includes stator iron core 204 that is formed by integrating the following two elements together:
a plurality of tooth sections 202 each one of which is independently formed of a coil-winding section wound directly by winding 201, and the coil-winding section being formed of soft magnetic material (hereinafter referred to as magnetic powder) made of insulating material or formed of magnetic powder having a low conductivity; and
yoke section 203 formed of magnetic powder and connecting the foregoing tooth sections to each other.

Another stator of the capacitor motor includes a stator iron core formed of a layered iron-core unit made by punching electromagnetic steel plates and layering the electromagnetic steel plates punched out. This stator also includes a dust core made of magnetic powder. This stator and a method of manufacturing the same iron core are proposed in, e.g. Unexamined Japanese Patent Publication No. 2004-201483.

FIG. 44 shows a stator iron core of the foregoing stator. The core includes core unit 301 formed by layering steel plates (hereinafter referred to as a layered iron-core unit) and core units 302 (hereinafter referred to as dust cores) formed by compounding magnetic powder and insulating material. Layered iron-core unit 301 is sandwiched by dust cores 302 placed on both the ends of iron-core unit 301 along the layering direction, and iron-core unit 301 is bonded to dust cores 302, thereby forming a core 303 (hereinafter referred to as a stator iron core).

A stator iron core (yoke section 401+tooth sections 402) shown in FIG. 45 and made of magnetic powder has, in general, a lower magnetic permeability than that of electromagnetic steel plate. To increase magnetic flux, dimensions of respective sections are preferably greater than the counterparts formed of the electromagnetic steel plate, e.g. width K of tooth section 402 is greater than that of the counter part formed of the laminated electromagnetic steel plates provided that the axial dimensions of both of the products are the same.

In the foregoing stator iron core or the stator of the conventional motor, or in the method of manufacturing the stator, parts of or the whole of the tooth sections are formed of dust core made of magnetic powder having a low magnetic flux density, so that the ratio of a sectional area (length of the tooth section along the axial direction×width) vs. layered iron-core unit should be increased. As a result, the length of the windings wound on the tooth sections is obliged to be longer, which invites greater loss consumed on the windings, so that the motor lowers its efficiency.

### DISCLOSURE OF INVENTION

A capacitor motor of the present invention comprises the following elements:
a stator including a stator iron core and windings; and
a rotor including a rotor iron core.

The stator iron core including:
a plurality of first divided iron-core units having tooth sections; and
a second divided iron-core unit which forms a magnetic path of the first divided iron-core units.

The windings are wound on the tooth sections and accommodated in a plurality of slots formed by the first divided iron-core units and the second divided iron-core unit.

The first divided iron-core units are formed by layering electromagnetic steel plates punched out, and the second divided iron-core unit is formed by molding magnetic powder into a given shape. The first divided iron-core units are combined by a given means with the second divided iron-core unit such that the tooth sections are arranged radially on an outer wall of the rotor iron core.

The present invention refers to a method of manufacturing the foregoing capacitor motor, and the method includes the following steps:
forming the first divided iron-core units by layering electromagnetic steel plates punched out;
forming the second divided iron-core unit by molding magnetic powder into a given shape;
mounting the windings on the tooth sections;
combining a plurality of the first divided iron-core units, on which the windings are mounted, with the second divided iron-core unit by a given means such that the first divided iron-core units are arranged radially on an inner wall of the second divided iron-core unit; and
inserting the rotor iron core along the inner wall of the first divided iron-core units.

The structure and the method discussed above allow the capacitor motor of the present invention to prevent cross sectional areas of the tooth sections and lengths of the windings from increasing, so that the motor can increase its efficiency. The structure and the method also allow enlarging a cross sectional area of the magnetic path of the yoke section without increasing an outer diameter of the stator iron core, so that the magnetic flux density can be lowered and the motor efficiency thus can be increased.

### BRIEF DESCRIPTION OF THE DRAWINGS

FIG. 1 shows a perspective view of a stator iron core of a capacitor motor in accordance with a first embodiment of the present invention.

FIG. 2 shows a sectional view in part of a stator of the capacitor motor in accordance with the first embodiment.

FIG. 3 shows a sectional view of the stator of the capacitor motor cut along line X1-X2 in FIG. 2.

FIG. 4 shows a front view of the stator iron core of the capacitor motor.

FIG. 5 shows a front view of a stator iron core formed of second divided iron-core units is further divided.

FIG. 6 shows a front view of a stator iron core formed by mating a recess of a first divided iron-core unit with a projection of a second divided iron-core unit of the capacitor motor.

FIG. 7 shows a front view of a stator iron core formed by mating the recess of the first divided iron-core unit with the projection of the second divided iron-core unit of the capacitor motor, and the second iron-core unit is further divided.

FIG. 8 shows a front view of another stator iron core formed of first divided iron-core units and second divided iron-core units of the capacitor motor, where the structures of both of the first and second divided iron-core units differ in dividing from those of the previous ones.

FIG. 9 shows a front view of still another stator iron core formed of first divided iron-core units and second divided iron-core units of the capacitor motor, where the structures of both of the first and second divided iron-core units differ in dividing from those of the previous ones.

FIG. 10 shows a sectional view illustrating a state where a stator of the capacitor motor is divided along the circumference direction.

FIG. 11 shows a perspective view of a stator iron core of a capacitor motor in accordance with a second embodiment of the present invention.

FIG. 12 shows a half sectional view illustrating a state where a stator and a rotor of the capacitor motor in accordance with the second embodiment are divided along the radius direction.

FIG. 13 shows a half sectional view illustrating a state where the stator of the capacitor motor is divided along the radius direction.

FIG. 14 shows a half sectional view illustrating a state where a stator and a rotor of a capacitor motor in accordance with a third embodiment of the present invention are divided along the radius direction.

FIG. 15 shows a half sectional view illustrating another state where a stator and a rotor of the capacitor motor in accordance with the third embodiment are divided along the radius direction.

FIG. 16 shows a sectional view in part of a stator of a capacitor motor in accordance with a fourth embodiment of the present invention.

FIG. 17 shows a half sectional view of a stator of the capacitor motor in accordance with the fourth embodiment.

FIG. 18 shows a front view of a stator iron core of the capacitor motor.

FIG. 19 shows a perspective view of a second divided iron-core unit of the capacitor motor.

FIG. 20 shows a perspective view of a first divided iron-core unit of the capacitor motor.

FIG. 21 shows a perspective view of a stator iron core formed by combining a first divided iron-core unit with a second divided iron-core unit of the capacitor motor.

FIG. 22 shows a front view of another stator iron core of the capacitor motor in accordance with the fourth embodiment.

FIG. 23 shows a front view of still another stator iron core of the capacitor motor in accordance with the fourth embodiment.

FIG. 24 shows a front view of yet another stator iron core of the capacitor motor in accordance with the fourth embodiment.

FIG. 25 shows a sectional view in part of a stator of a capacitor motor in accordance with a fifth embodiment of the present invention.

FIG. 26 shows a half sectional view of a stator of the capacitor motor.

FIG. 27 shows a perspective view of a second divided iron-core unit of the capacitor motor, and the unit is further divided.

FIG. 28 shows a perspective view of a stator iron core formed by combining a first divided iron-core unit with the second divided iron-core unit further divided.

FIG. 29 shows a perspective view illustrating a state where a second divided iron-core unit of a capacitor motor in accordance with a sixth embodiment of the present invention is further divided.

FIG. 30 shows a sectional view of a capacitor motor in accordance with a seventh embodiment of the present invention.

FIG. 31 shows a sectional view illustrating a state where a first cup-like member and a rotor are removed from the capacitor motor in accordance with the seventh embodiment.

FIG. 32 shows a top view illustrating a state where the first cup-like member and the rotor are removed from the capacitor motor in accordance with the seventh embodiment.

FIG. 33 shows a half sectional view of the capacitor motor.

FIG. 34 shows a half sectional view illustrating a state where the first cup-like member and the rotor are removed from the capacitor motor in accordance with the seventh embodiment.

FIG. 35 shows a top view illustrating a state where a second cup-like member and a first divided iron-core unit are combined together.

FIG. 36 shows a perspective view illustrating a state where the second cup-like member, from which a projection for rigidly mounting is removed, is combined with the first iron-core unit of the capacitor motor.

FIG. 37 shows a top view of a second cup-like member of the capacitor motor.

FIG. 38 shows a perspective view of the first divided iron-core unit of the capacitor motor.

FIG. 39 shows a sectional view of the first cup-like member of the capacitor motor.

FIG. 40 shows a sectional view of the second cup-like member of the capacitor motor.

FIG. 41 shows a top view illustrating a state where a second cup-like member having four projections for rigidly mounting is combined with first divided iron-core units wound with windings.

FIG. 42 shows a sectional view of a capacitor motor in accordance with an eighth embodiment, the motor includes ring-like members Ca and Cb of which thickness is similar to a thickness of a second divided iron-core unit along the radius direction.

FIG. 43 shows a plan view of a stator of a conventional capacitor motor.

FIG. 44 shows a perspective view of a stator iron core of another conventional capacitor motor.

FIG. 45 shows a plan view of a stator iron core of another conventional capacitor motor.

### DESCRIPTION OF REFERENCE MARKS

1, 21, 51 slot
2, 22, 52 stator iron core
3, 23, 53 tooth section
4, 24, 54 first divided iron-core unit
5, 25, 55 yoke section
6, 26, 56 second divided iron-core unit
7, 27, 57 insulating bobbin
8, 9, 28, 29, 58, 59 winding
10, 30, 66 stator
11, 31, 35, 61, 65 recess
12, 32, 34, 62, 64 projection
13, rotor iron core
14, 74 rotor
15 third divided iron-core unit
39, 69 mounting section
70A, 70B cup-like member
76A, 76B ring-like member
77A, 77B lid

### DETAILED DESCRIPTION OF PREFERRED EMBODIMENTS

Exemplary embodiments of the present invention are demonstrated hereinafter with reference to the accompanying drawings.

### Embodiment 1

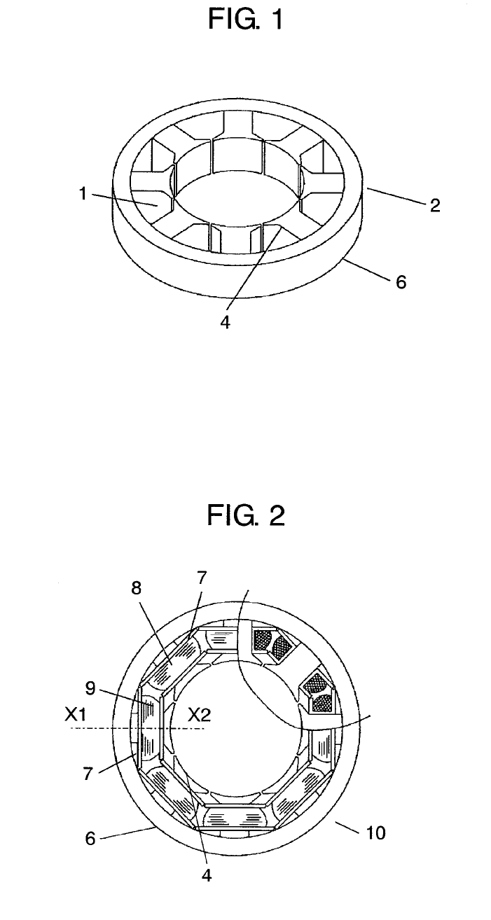

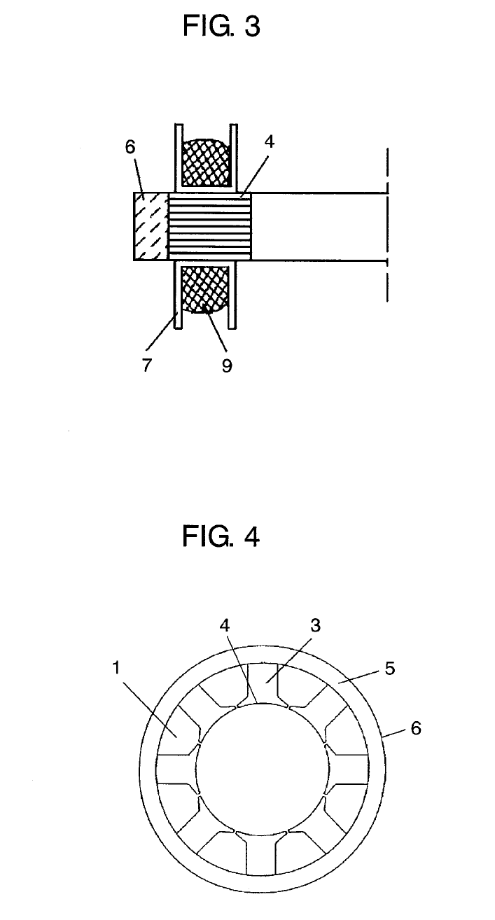

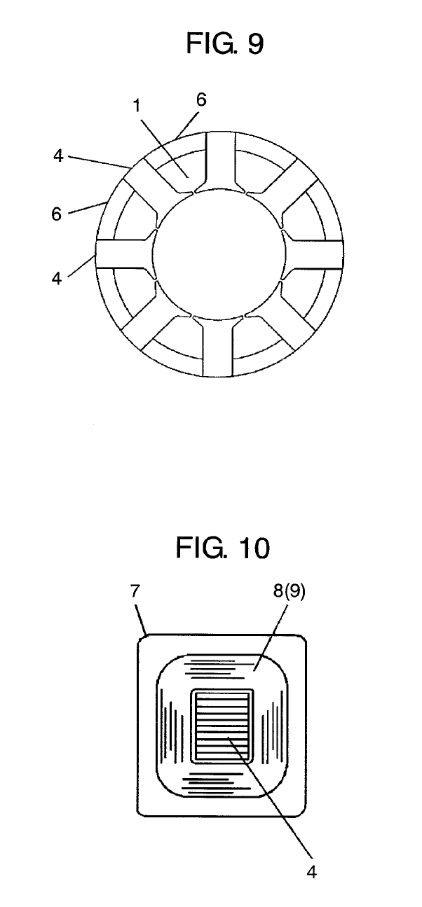

FIG. 1-FIG. 10 show stators of a capacitor motor in accordance with the first embodiment of the present invention. As these drawings show, the capacitor motor of the present invention includes stator iron core 2 having eight pieces of slots 1. Stator iron core 2 having eight slots 1 is divided into the following two iron-core units, namely, first divided iron-core unit 4 and second divided iron-core unit 6:
eight pieces of first divided iron-core unit 4 each of which mainly forms tooth section 3; and
second divided iron-core unit 6 which forms a magnetic path as yoke section 5 on the outer walls of slots 1 and first divided iron-core units 4. Each one of first divided iron-core units 4 is formed by punching electromagnetic steel plates and layering the steel plates punched out, and each one of tooth sections 3 is mounted with phase-A winding 8 or phase-B winding 9, both of windings 8 and 9 being wound on insulating bobbins 7. Iron-core units 4 mounted with phase-A winding 8 and those mounted with phase-B winding 9 are alternately arranged in an annular shape. Second divided iron-core unit 6 is placed along the outer walls of first divided iron-core units 4 and formed of dust core which is made by molding magnetic powder into a given shape. First divided iron-core units 4 and second divided iron-core unit 6 are integrated together by bonding, welding, or mechanical joint, so that stator 10 is formed.

As shown in FIG. 6-FIG. 9, second divided iron-core unit 6 is shaped such that iron-core unit 6 surrounds yoke sections 5 entirely or partially. Yoke section 5 forms magnetic paths on the outer wall of first divided iron-core units 4. Other yoke sections 5, which form no magnetic paths, are formed of dust core made by molding magnetic powder into a given shape.

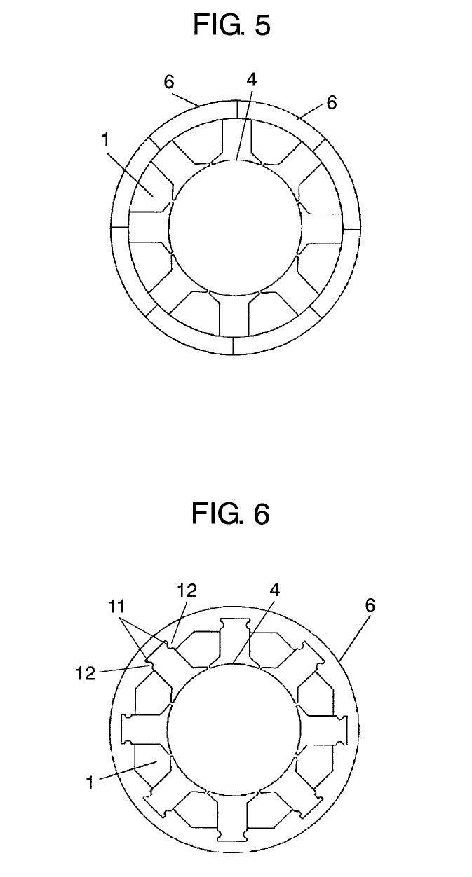

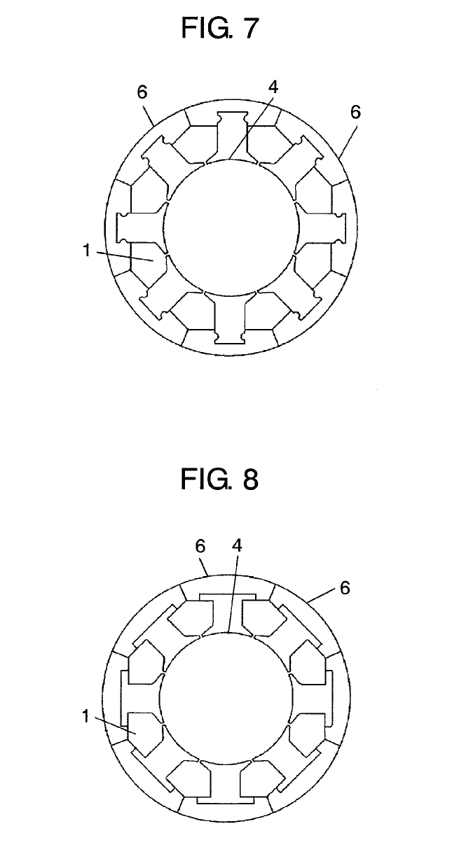

As shown in FIGS. 6 and 7, each one of first divided iron-core units 4 has a recess 11 on each side along the circumference direction so that iron-core unit 4 can be mated with projection 12 provided to second divided iron-core unit 6. Second divided iron-core unit 6 shown in FIGS. 4 and 6 are divided along the circumference direction into plural pieces which are shown in FIGS. 5 and 7.

Since each one of first divided iron-core units 4, which mainly form tooth sections 3 to be mounted or wound with the windings, is formed by punching electromagnetic steel plates and layering the steel plates punched out, iron-core unit 4 has a smaller sectional area of the magnetic path than another iron-core unit formed of magnetic powder entirely or partially. Thus the length of phase-A winding 8 or phase-B winding 9 mounted or wound on tooth section 3 can be shortened, and the windings have a smaller resistance value. As a result, the loss consumed on the windings can be lowered and the efficiency of the motor can be increased.

The foregoing structure allows simply assembling first divided iron-core units 4 and second divided iron-core unit 6 together by mating through press-fitting. The foregoing structure also allows downsizing a molding die of second divided iron-core unit 6 formed of magnetic powder.

In this first embodiment, the stator iron core has eight slots; however, any number of slots can be employed. The insulating bobbin is used for insulating the winding of each phase from the stator iron core; however, insulating film or powder can be used instead.

### Embodiment 2

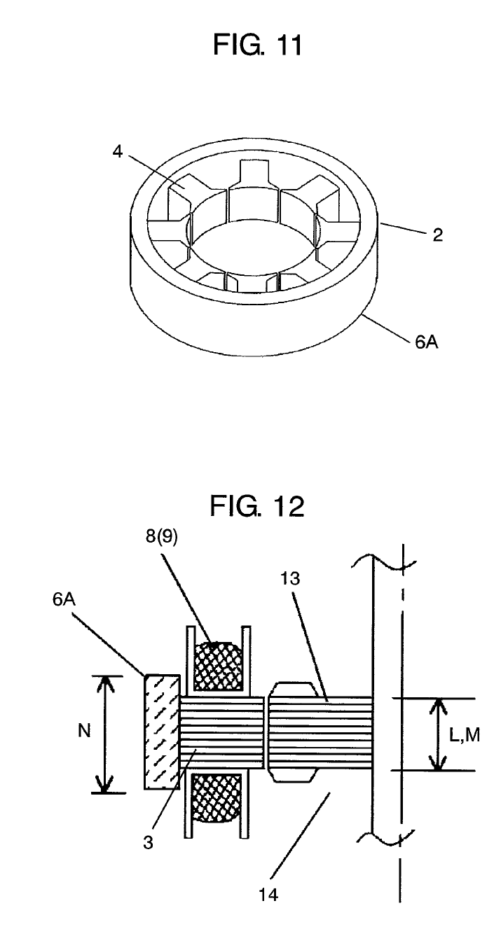

The second embodiment is demonstrated with reference to FIG. 11-FIG. 13. Similar elements to those in the first embodiment have the same reference marks, and the descriptions thereof are omitted here.

What are shown in FIGS. 11 and 12 differ from the first embodiment in the following points: Second divided iron-core unit 6A has thickness N along the axial direction, and tooth section 3 of first divided iron-core unit 4 has thickness L along the axial direction. Thickness N is set longer than thickness L. Another point is this: Rotor 14 is provided inside of stator iron core 2, and rotor 14 holds rotor iron core 13 coaxially and rotatably, and rotor iron core 13 has axial thickness M equal to axial thickness L of first divided iron-core unit 6A. Other structures remain unchanged from those of the first embodiment, for instance, second divided iron-core unit 6A is formed of dust core which is made by molding magnetic powder into the given shape, and first divided iron-core unit 4 is formed by punching electromagnetic steel plates and layering the steel plates punched out.

The foregoing structure allows forming a magnetic path as a yoke section on an outer wall of stator iron core 2. Axial length N of second iron-core unit 6A, which is formed by dust core made by molding magnetic powder and can be formed into any shape with ease because of the material, is set longer than axial length L of tooth section 3 wound or mounted with phase-A winding 8 or phase-B winding 9. The sectional area of the magnetic path, i.e. the yoke section of second divided iron-core unit 6A, can be thus increased, and the magnetic flux density can be lowered, so that the motor can increase its efficiency.

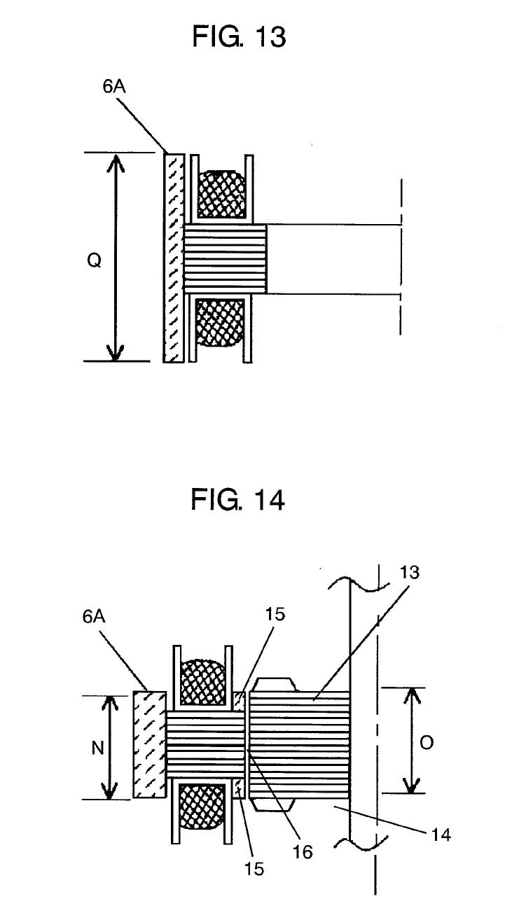

As shown in FIG. 13, an additionally longer axial dimension “Q” of second divided iron-core unit 6A allows shortening the outer diameter of this second divided iron-core unit 6A, so that both of the stator iron core and the stator itself can shorten their outer diameters respectively. As a result, the overall outer diameter of the motor can be shortened.

A magnetic flux density at the magnetic path of rotor iron core 13 is lowered, so that the motor efficiency can be increased.

### Embodiment 3

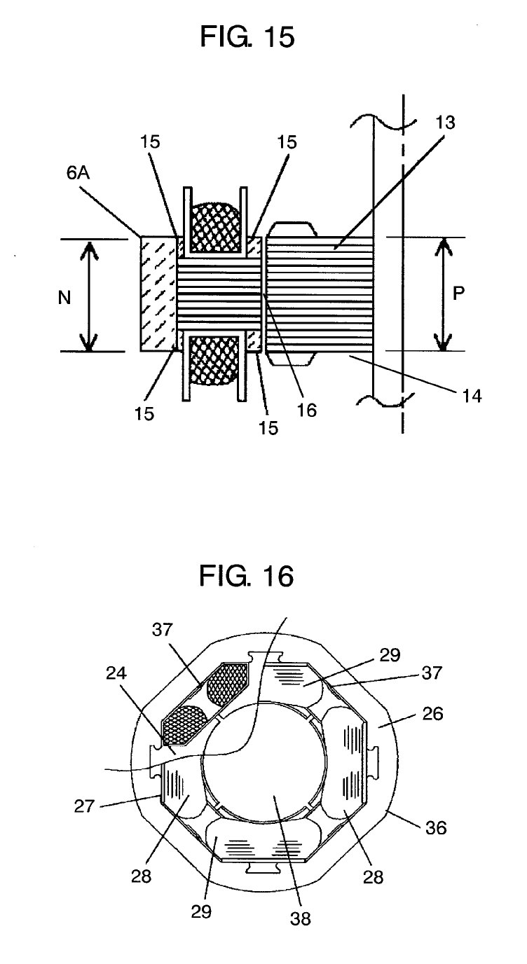

The third embodiment is demonstrated with reference to FIG. 14-FIG. 15. Similar elements to those in the first and the second embodiments have the same reference marks, and the descriptions thereof are omitted here.

What are shown in FIGS. 14 and 15 differ from the first and the second embodiments in the following points: Second divided iron-core unit 6A has an axial thickness set longer than that of tooth section 3 of first divided iron-core unit 4. Another point is this: third divided iron-core unit 15 is additionally provided to each one of first divided iron-core units 4 at their front and rear faces along their outer walls as well as at the tips of front and rear faces along their inner walls, both of the front and rear faces being axially disposed and no windings being mounted or wounded thereon. Third divided iron-core unit 15 is formed of dust core which is made by molding magnetic powder into a given shape, so that iron-core unit 15 can be formed into any shape with ease. Other structures remain unchanged from those of the first or the second embodiment. For instance, second divided iron-core unit 6A is formed of dust core which is made by molding magnetic powder into the given shape, and first divided iron-core unit 4 is formed by punching electromagnetic steel plates and lay-ring the steel plates punched out.

Stator iron core 2 includes rotor 14 having rotor iron core 13 held coaxially and rotatably. First divided iron-core unit 4 includes additionally third divided iron-core unit 15 which is formed of layered electromagnetic steel plates or dust core that is made by molding magnetic power into the given shape. This first divided iron-core unit 4 with third divided iron-core unit 15 has axial thickness N set equal to an axial thickness “O” or “P” of rotor iron core 13.

The foregoing structure includes third divided iron-core unit 15 that is additionally provided to each one of first divided iron-core units 4 at its axial front and rear faces on the outer wall as well as the tips of axial front and rear faces on the inner wall, namely iron-core units 15 are provided to sections where no winding is mounted or wound. As previously discussed, third divided iron-core unit 15 is formed of dust core which is made by molding magnetic powder, or formed of layered magnetic steel plates. This third divided iron-core unit 15 advantageously lowers the magnetic flux density at the magnetic path, so that the motor can increase its efficiency.

The foregoing structure allows lowering the magnetic flux density at the magnetic path of rotor iron core 13 as well as at air gap 16 between rotor iron core 13 and stator iron core 2, so that the motor can increase its efficiency.

In this third embodiment, the stator iron core employs eight slots; however, the advantage of the present invention is not limited to the number of slots. The foregoing structure is applicable to not only the capacitor motor but also other motors which employ concentrated windings.

### Embodiment 4

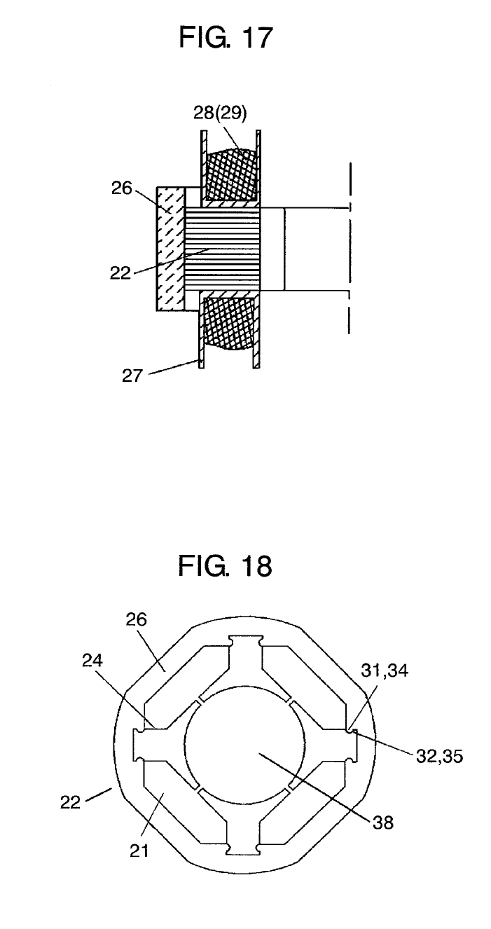

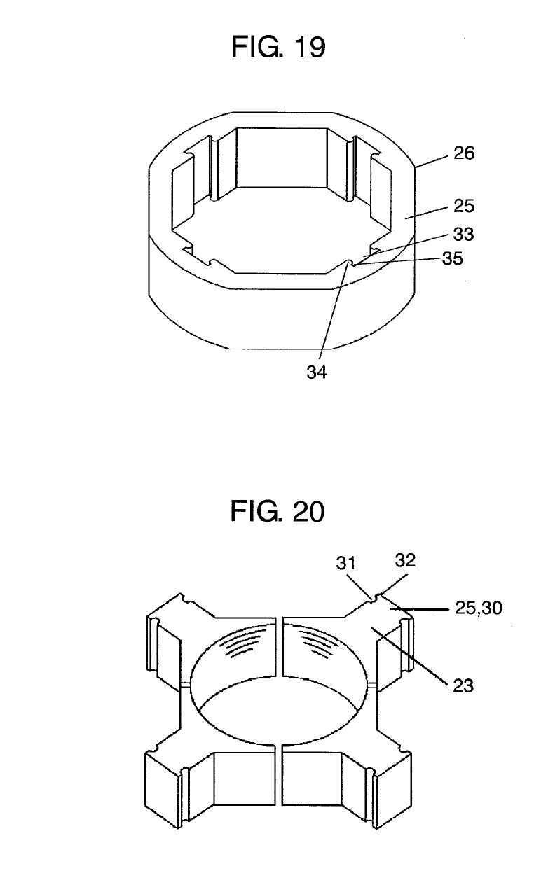

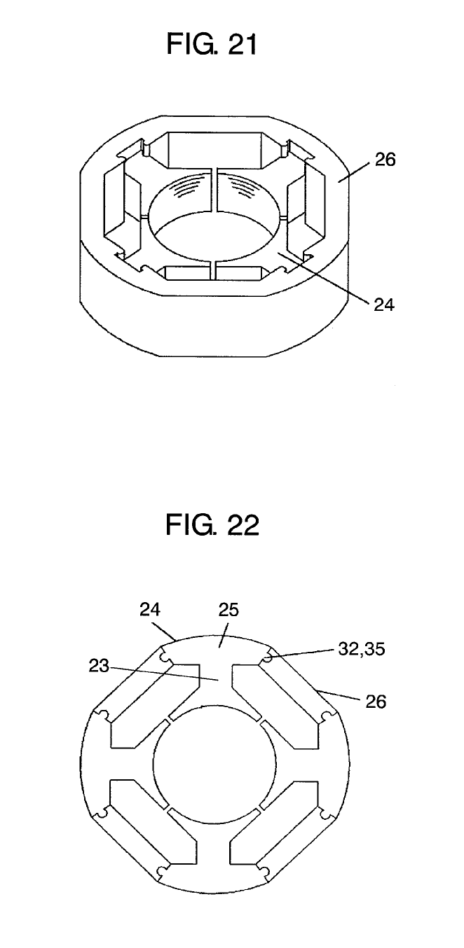

FIG. 16-FIG. 21 show stators and a capacitor motor in accordance with the fourth embodiment. The capacitor motor comprises stator iron core 22 having four slots 21, and stator iron core 22 is divided into the following elements:
four pieces of first divided iron-core units 24 each of which mainly forms tooth section 23; and
second divided iron-core unit 26, which forms a magnetic path as yoke section 25 on the outer walls of first divided iron-core unit 24 and slots 21, having a thickness along the rotor axis longer than that of first divided iron-core unit 24.
   Each one of first divided iron-core units 24 is formed by punching electromagnetic steel plates and layering the steel plates punched out, and each one of tooth sections 23 is mounted with insulating bobbin 27 on which phase-A winding 28 or phase-B winding 29 is wound. First divided iron-core units 24 mounted with phase-A winding 28 and those mounted with phase-B winding 29 are alternately arranged radially along the rim of rotor hole 38. Recess 31 and projection 32 of protrusion 30 provided to a tip of outer wall of each one of first divided iron-core units 24 can be mated with projection 34 and recess 35 provided to groove 33 of second iron-core unit 26, thereby forming stator 36. The mating can be realized by a simple mechanical assembly such as press-fitting, or other method upon necessary such as welding, bonding or a method of mixing some of them. Second divided iron-core unit 26 is placed outside first divided iron-core units 24 and formed of dust core which is made by molding magnetic powder into the given shape. Slot insulating film 37 is disposed between the windings and stator iron core 22 for electrically insulating them together with insulating bobbin 27.

Since each one of first divided iron-core units 24, which mainly form tooth sections 23 to be mounted or wound with the windings, is formed by punching electromagnetic steel plates and layering the steel plates punched out, iron-core unit 24 has a smaller sectional area of magnetic path than another iron-core unit formed of magnetic powder entirely or partially. Thus the length of phase-A winding 28 or phase-B winding 29 mounted or wound on tooth section 23 can be shortened, and the windings have a smaller resistance value. As a result, the loss consumed on the windings can be lowered and the efficiency of the motor can be increased. The length of second divided iron-core unit 26 along the rotor axis is set longer than that of first divided iron-core unit 24, so that the sectional area of the magnetic path can be increased, which increases the total number of magnetic fluxes. As a result, the motor can increase its efficiency. Tooth section 23 of first divided iron-core unit 24 forms a solid shape up to its outer end, namely, it keeps the same width and thickness up to its outer end, so that the prepared winding can be mounted on bobbin 27 as well as the winding can be directly wound on bobbin 27 mounted to first divided iron-core unit 24. First divided iron-core 24 can be simply integrated with second divided iron-core 26 by press-fitting.

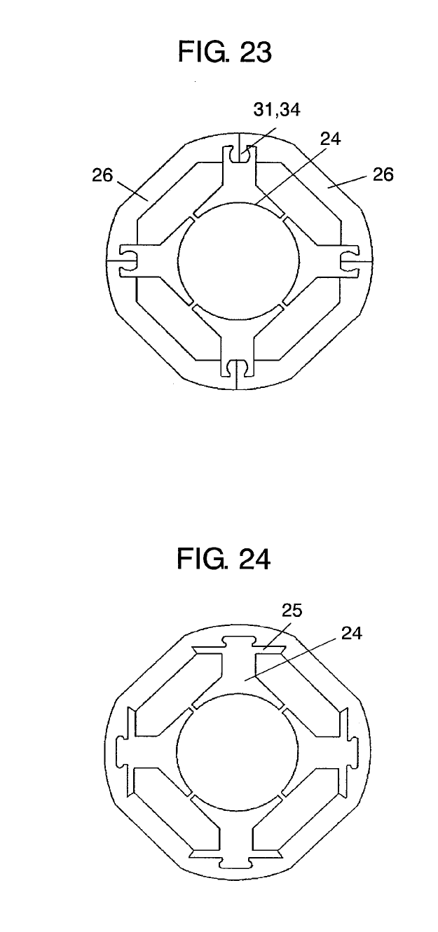

The stator shown in FIG. 23 allows mounting the prepared windings on insulating bobbins 27 as well as winding directly the windings on bobbins 27 mounted to first divided iron-core units 24. This structure allows downsizing the molding die of second divided iron-core unit 26 which is formed of magnetic powder. The stator shown in FIG. 24 allows preventing bobbin 27 from being deformed when the winding is wound on bobbin 27 mounted to first divided iron-core unit 24, because an inner part of yoke section 25 is integrated with iron-core unit 24, so that the winding job can be done more efficiently.

In this fourth embodiment, the stator iron core employs four slots; however, it can employ any number of slots, and the respective windings are insulated by mainly the insulating bobbins; however, insulating film or powder can be used instead.

Yoke section 25 or second divided iron-core unit 26 can be divided along the circumference direction as shown in FIG. 22: First divided iron-core unit 24, which is formed by punching electromagnetic steel plates and layering the steel plates punched out, is unitarily formed with yoke section 25, which forms a magnetic path at its outer wall. Other yoke sections 25, which form no magnetic paths, are formed of dust core which is made by molding magnetic powder into a given shape. First divided iron-core units 24 adjacent to each other are coupled together by second divided iron-core unit 26 which is split into four pieces. To be more specific, projection 32 provided to an outer end of yoke section 25 in first divided iron-core unit 24 is mated with recess 35 provided to outer end of second divided iron-core unit 26, so that unit 24 is integrated with unit 26.

The stator shown in FIG. 23 is structured as follows: first divided iron-core unit 24 formed by punching electromagnetic steel plates and layering the steel plates punched out is protruded to yoke section 25, which forms a magnetic path at its outer wall. Recess 31 provided to an outer end of unit 24 is mated with projection 34 provided to the circumferential end of second divided iron-core unit 26 which is split into four pieces, so that unit 24 is integrated with unit 26.

The stator shown in FIG. 24 is structured as follows: First divided iron-core unit 24 formed by punching electromagnetic steel plates and layering the steel plates punched out is unitarily formed with an inner part of yoke section 25, which forms a magnetic path at its outer wall.

### Embodiment 5

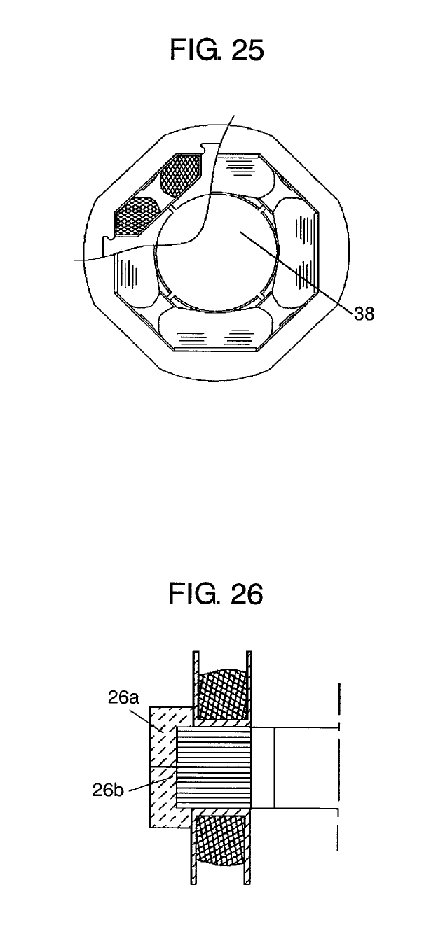

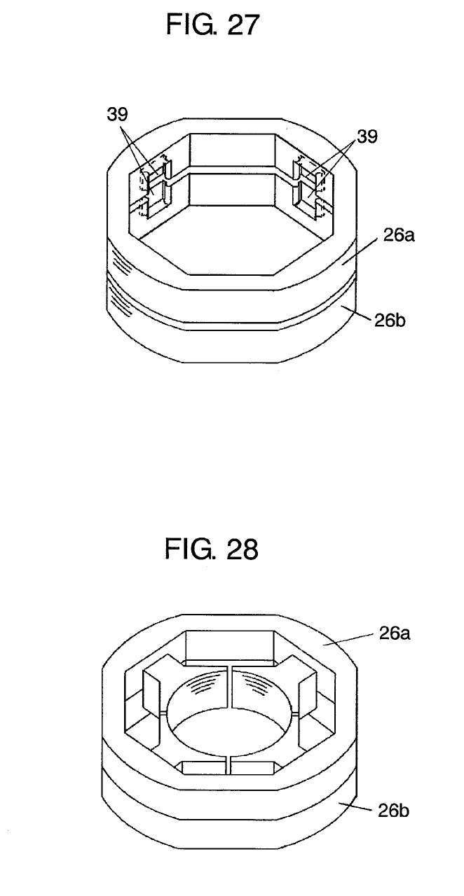

The fifth embodiment is demonstrated hereinafter with reference to FIG. 25-FIG. 28. The fifth embodiment differs from the fourth one in the following points: Second divided iron-core 26, formed of dust core which is made by molding magnetic powder into a given shape, is split into two pieces horizontally, namely, in a direction at right angles to the rotor axis. Each one of two pieces is referred to as second divided iron-core unit 26a and unit 26b. Mounting sections 39 are provided to positions which split the inner circumference of units 26a and 26b into four sections, and the outer wall of first divided iron-core unit 24 is placed at mounting sections 39 so that units 26a and 26b can tightly hold or sandwich first iron-core unit 24 in order to assemble first divided iron-core unit 24 and second divided iron-core unit 26 together. In FIG. 25-FIG. 28, similar elements to those shown in FIG. 16-FIG. 24 have the same reference marks, and the descriptions thereof are omitted here.

Since each one of first divided iron-core units 24, which mainly form tooth sections 23 to be mounted or wound with the windings, is formed by punching electromagnetic steel plates and layering the steel plates punched out, unit 24 has a smaller sectional area of the magnetic path than another iron-core unit formed of magnetic powder entirely or partially. Thus the length of phase-A winding 28 or phase-B winding 29 mounted or wound on tooth section 23 can be shortened, and the windings have a smaller resistance value. As a result, the loss consumed on the windings can be lowered and the efficiency of the motor can be increased. The length of second divided iron-core unit 26 along the rotor axis is set longer than that of first divided iron-core unit 24, so that the sectional area of the magnetic path can be increased, which increases the total number of magnetic fluxes. As a result, the motor can increase its efficiency. Tooth section 23 of first divided iron-core unit 24 forms a solid shape up to its outer end, namely, it keeps the same width and thickness up to its outer end, so that the prepared winding can be mounted on bobbin 27 as well as the winding can be directly wound on bobbin 27 mounted to first divided iron-core unit 24. The first divided iron-core units are placed at mounting sections 39 of which positions split the inner circumference of second divided iron-core units 26a and 26b into four sections, so that the first divided iron-core units are well positioned along the circumference direction. As a result, the first divided iron-core units 24 can be rigidly and accurately mounted with ease.

Since second divided iron-core unit 26 is split into two pieces horizontally at the half height along the axial direction, namely, split into upper piece 26a and lower piece 26b, this structure allows downsizing a molding die from that of non-split unit 26. As a result, the cost of the molding die can be reduced.

First divided iron-core units 24 can be more rigidly mounted because upper piece 26a and lower piece 26b tightly sandwich them in addition to press-fitting, so that vertical vibrations produced by the electromagnetic steel plates forming first divided iron-core units 24 can be reduced.

In manufacturing this stator, follow the steps below:
mount four pieces of first divided iron-core unit 24 in a batch or one by one sequentially to mounting sections 39 which are provided to second divided iron-core unit 26a or 26b, where each one of iron-core units 24 is directly wound with the windings or mounted with the windings; and then
mount second divided iron-core unit 26b or 26a for assembling the stator iron core.
   Iron-core unit 26a and unit 26b are jointed together by bonding, welding or other methods; however, they are not necessarily jointed but can be held by the tooth sections formed by layering electromagnetic steel plates.
   The foregoing procedure allows first divided iron-core units 24 to be mounted to second divided iron-core unit 26 manually without introducing a dedicated automatic assembling machine. Not to mention, the foregoing procedure can be automated by the automatic assembling machine.

In this fifth embodiment, mounting sections 39 are provided to both of second divided iron-core units 26a and 26b; however, they can be provided to either one of them.

### Embodiment 6

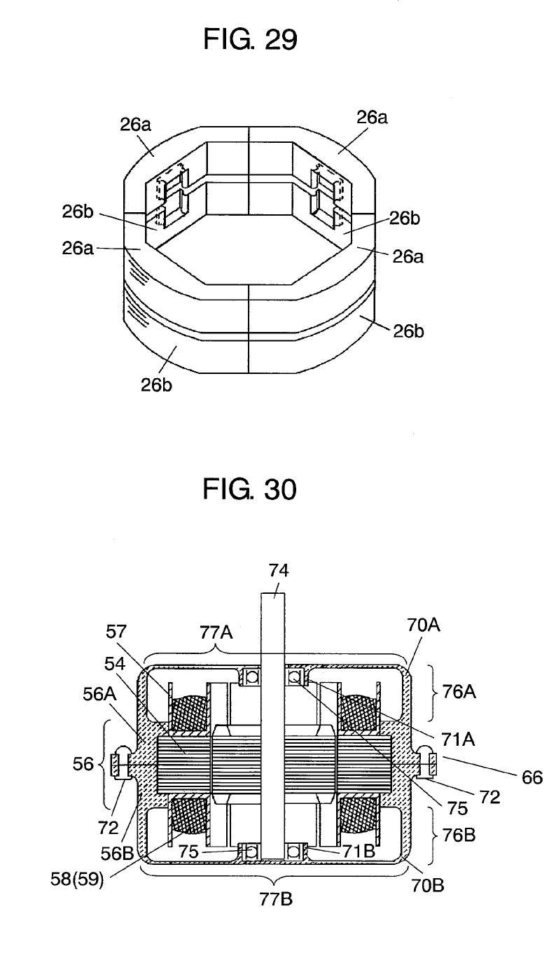

The stator shown in FIG. 29 in accordance with the sixth embodiment differs from that of the fifth embodiment in the following points: At the positions between respective mounting sections 39 of which positions split the inner circumference of second divided iron-core units 26a and 26b into four sections, the inner circumference is further split into four sections, namely, it is split into eight sections. As discussed in the preceding fifth embodiment, second divided iron-core unit 26 formed of dust core, which is made by molding magnetic powder into the given shape, is split into two units 26a and 26b horizontally, i.e. in a direction at right angles to the rotor axis.

The foregoing structure allows downsizing second divided iron-core units 26a and 26b, so that their molding die can be downsized for streamlining the manufacturing process.

The stator iron cores in accordance with embodiments 4, 5 and 6 employ four slots; however, the advantages of the present invention are not limited by the number of slots, and the preceding structures are applicable not only to the capacitor motor but also to other motors which employ a concentrated winding. In the sixth embodiment, second divided iron-core unit 26 is split into four sections along the circumference direction; however it can be split into any number. The split sections are jointed by bonding or welding; however, they can be structured so as to be jointed by mechanical assembly.

### Embodiment 7

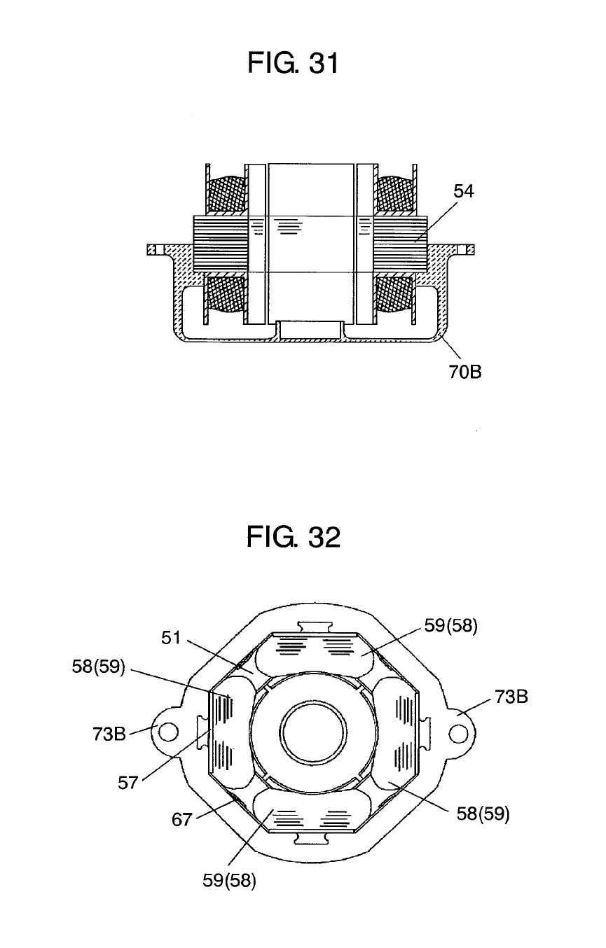

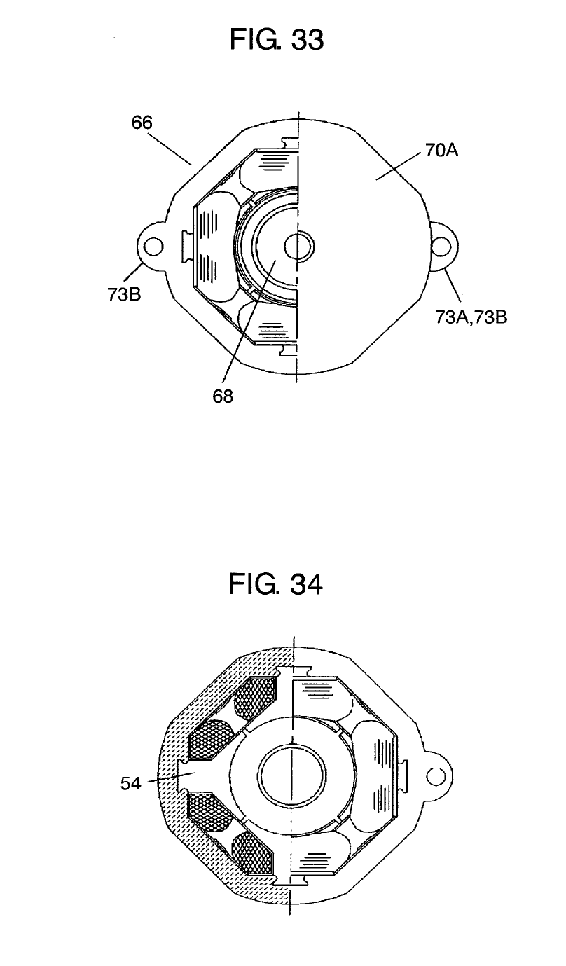

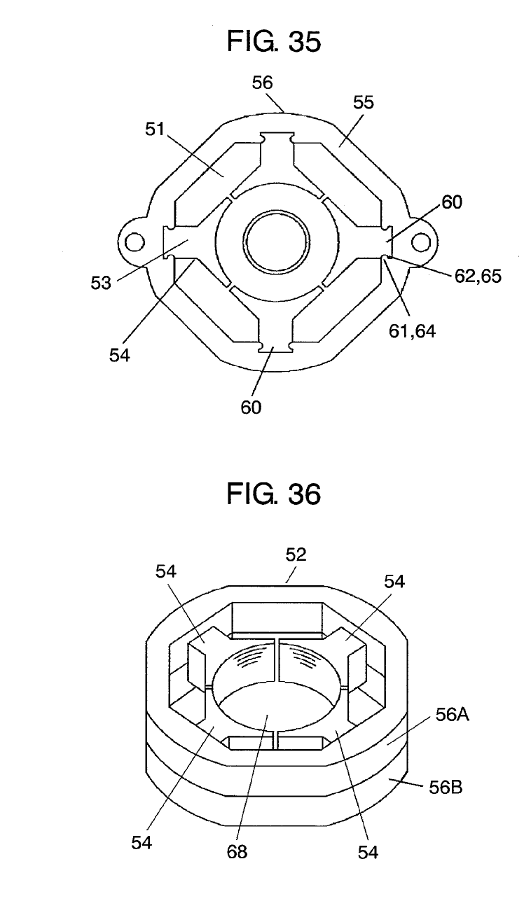

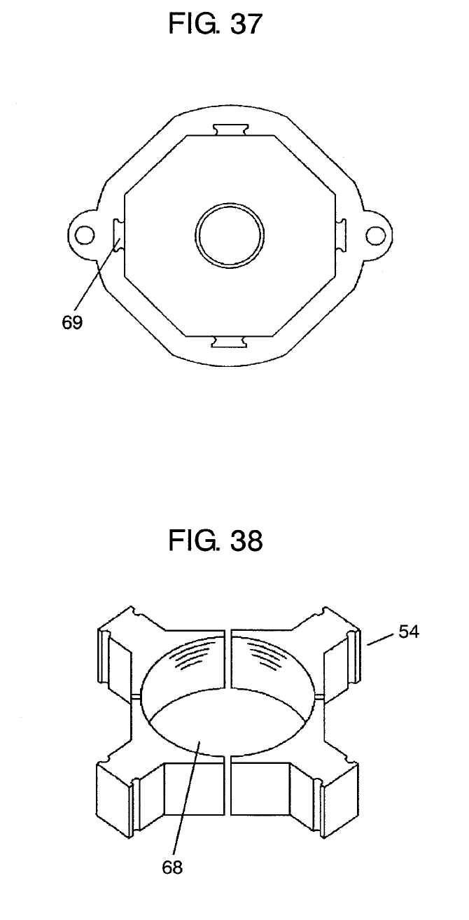

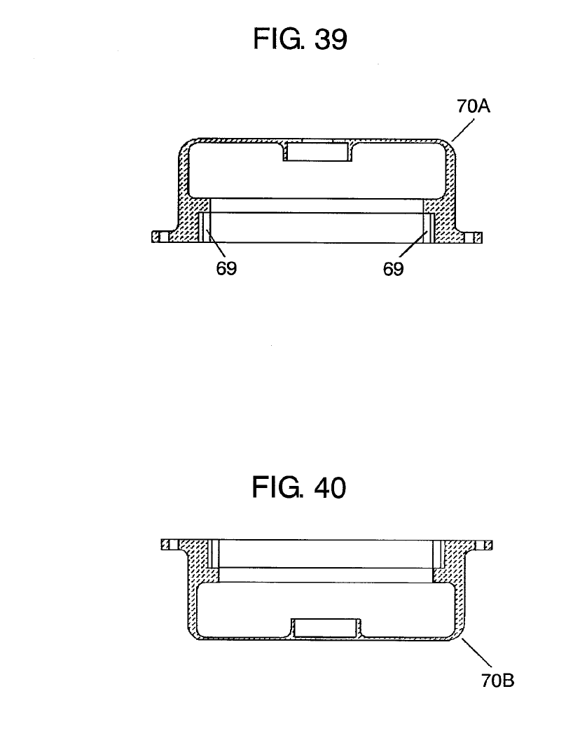

FIG. 30-FIG. 41 show stators and a capacitor motor in accordance with the seventh embodiment. The capacitor motor in accordance with the seventh embodiment comprises stator iron core 52 having four slots 51, and stator iron core 52 can be divided into the following elements:
four pieces of first divided iron-core unit 54 each of which mainly forms tooth section 53; and
second divided iron-core unit 56 forming yoke section 55, which produces a magnetic path at the outer wall of first divided iron-core units 54 and slots 51, and having an axial thickness longer than the thickness of first divided iron-core unit 54 along the rotor axis.
   Each one of first divided iron-core units 54 is formed by punching electromagnetic steel plates and layering the steel plates punched out, and each one of tooth sections 53 is mounted with insulating bobbin 57 wound with phase-A winding 58 or phase-B winding 59. Iron-core units 54 mounted with phase-A winding 58 and iron-core units 54 mounted with phase-B winding 59 are alternately and radially arranged in an annular shape around rotor hole 68. Second divided iron-core unit 56 is formed of dust core which is made by molding magnetic powder into a given shape, and split into two units 56A and 56B horizontally, to be more specific, in a direction at right angles to the rotor axis. Two units 56A and 56B are placed on the outer walls of first divided iron-core units 54. Mounting sections 69 are provided at the positions which split the inner circumference of units 56A and 56B into four sections. Protrusions 60 provided at the outer tips of first divided iron-core units 54 are sandwiched vertically by mounting sections 69 of units 56A and 56B, whereby stator 66 is formed. As FIG. 35 shows, recess 61 and projection 62 of first divided iron-core unit 54 are mated with projection 64 and recess 65 of second divided iron-core unit 56.

Second divided iron-core units 56A and 56B, made of dust core, form partially cup-like member 70A and second cup-like member 70B respectively. Cup-like members 70A and 70B respectively form parts of the housing of the motor, and comprise the following elements:
second divided iron-core units 56A and 56B forming a ring-shaped lateral face of the housing on the outer walls of first divided iron-core units 54;
ring-shaped sections 76A and 76B forming a ring-shaped lateral face of the housing around the outer walls of the stator windings, and being solid from iron-core units 56A and 56B; and
lid sections 77A and 77B.
   Bearing holders 71A and 71B are unitarily formed with lid sections 77A and 77B at the center of lid sections 77A and 7713 respectively, thereby rotatably holding bearing 75 of rotor 74. An average wall thickness of cup-like members 70A and 70B except second divided iron-core units 56A and 56B is set thinner than the radial thickness of units 56A and 56B. Protrusions 73A and 73B for receiving fastening members 72 are provided at the same positions of the edges of the plural mating surfaces of iron-core units 56A and 56B to be integrated together. Fastening members 72 are used for integrating unit 56A with unit 56B together, and protrusions 73A and 73B are unitarily formed with units 56A and 56B. Slot insulating film 67 electrically insulates the winding from stator iron core 52 as insulating bobbin 57 does.

Since each one of first divided iron-core units 54, which mainly form tooth sections 53 to be mounted or wound with the windings, is formed by punching electromagnetic steel plates and layering the steel plates punched out, unit 54 has a smaller sectional area of magnetic path than another iron-core unit entirely or partially formed of magnetic powder. Thus the length of phase-A winding 58 or phase-B winding 59 mounted or wound on tooth section 53 can be shortened, and the windings have a smaller resistance value. As a result, the loss consumed on the windings can be lowered and the efficiency of the motor can be increased. The length of second divided iron-core unit 56 along the rotor axis is set longer than that of first divided iron-core unit 54, so that the sectional area of the magnetic path can be increased, which increases the total number of magnetic fluxes. As a result, the motor can increase its efficiency. Cup-like members 70A and 70B are formed of dust core and integrated into one body, and ring-shaped sections 76A, 76B, lid sections 77A, 77B are solid with second divided iron-core units 56A, 56B respectively, so that these elements work as yoke sections 55 for making a magnetic path on the outer walls of first divided iron-core units 54. As a result, the magnetic flux density is lowered for further increasing the motor efficiency.

Tooth section 53 of first divided iron-core unit 54 forms a solid shape up to its outer end, namely, it keeps the same width and thickness up to its outer end, so that the winding can be directly wound on bobbin 57 mounted to first divided iron-core unit 54 as well as bobbin 57 wound with the winding can be mounted to iron-core unit 54. The first divided iron-core units are placed at mounting sections 69 of which positions split the inner circumference of second divided iron-core units 56A and 56B into four sections, so that first divided iron-core units 54 are well positioned along the circumference direction. As a result, the first divided iron-core units 54 can be rigidly and accurately mounted with ease.

First divided iron-core units 54 can be more rigidly mounted because upper piece 56A and lower piece 56B tightly sandwich them in addition to press-fitting, so that vertical vibrations produced by the electromagnetic steel plates forming first divided iron-core units 54 can be reduced.

In manufacturing this stator, follow the steps below:
mount four units of first divided iron-core unit 54 in a batch or one by one sequentially to mounting sections 69 which are provided to second divided iron-core unit 56A or 56B, where each one of iron-core units 54 is directly wound with the windings or mounted with the windings; and then
mount second divided iron-core unit 56B or 56A for assembling the stator iron core.
   The foregoing process allows first divided iron-core units 54 to be mounted to second divided iron-core unit 56 manually without introducing a dedicated automatic assembling machine. Not to mention, the foregoing procedure can be automated by the automatic assembling machine.

First divided iron-core units 54 and second divided iron-core unit 56 can be assembled together simply by press-fitting. Since the average wall thickness of cup-like members 70A, 70B is thinner than that of second divided iron-core units 56A, 56B, and also cup-like members 70A, 70B are unitarily formed with bearing holders 71A, 71B respectively, the amount of magnetic powder for forming the magnetic core can be reduced, thereby decreasing the weight of the elements made of the magnetic powder. The foregoing structure allows saving other components necessary for holding bearing 75, so that the number of components can be reduced and a simpler structure can be expected. First cup-like member 70A and second cup-like member 70B can be integrated together tightly with ease by mounting fastening members 72 such as screws or riveting-pins to protrusions 73.

In this seventh embodiment, second divided iron-core unit 56 is split into two units in a direction at right angles to the rotator axis, and each one of the two units is unitarily formed with cup-like member 70A and 70B respectively; however, second divided iron-core unit 56 is not necessarily split but it can be unitarily formed with either one of cup-like member 70A or 70B. In the case of unitarily forming iron-core unit 56 with cup-like member 70A (or 70B), counter part cup-like member 70B (or 70A) is provided with protrusions for holding iron-core unit 56, thereby fixing second divided iron-core unit 56 to these protrusions.

In this embodiment, respective phase-windings are insulated from stator iron core 52 with the insulating bobbins together with insulating film; however, insulating film 67 can do this job alone, or an insulating structure using insulating powder can be available. The dust core made of magnetic powder is an aggregate of iron powder which includes insulating coating, so that the dust core has a higher degree of proper resistance comparing with the motor housing made of iron plate. As a result, the motor using the dust core assures a higher level of safety.

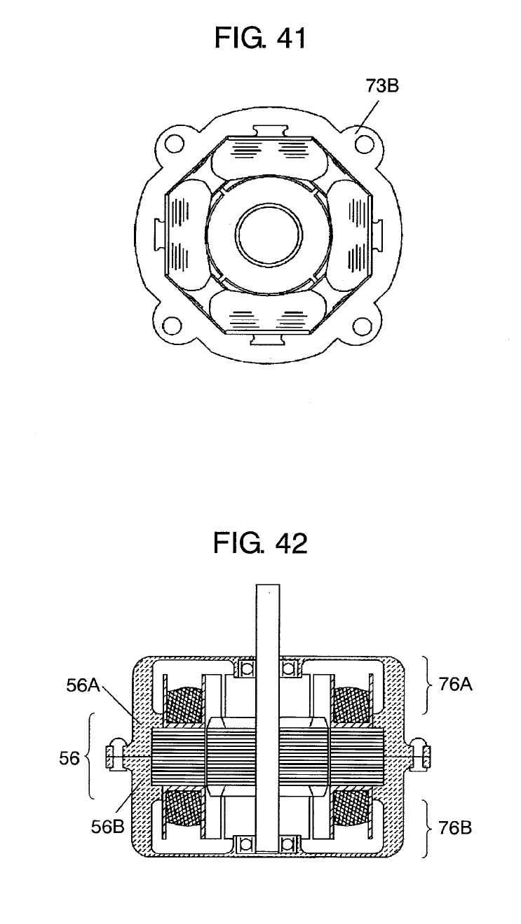

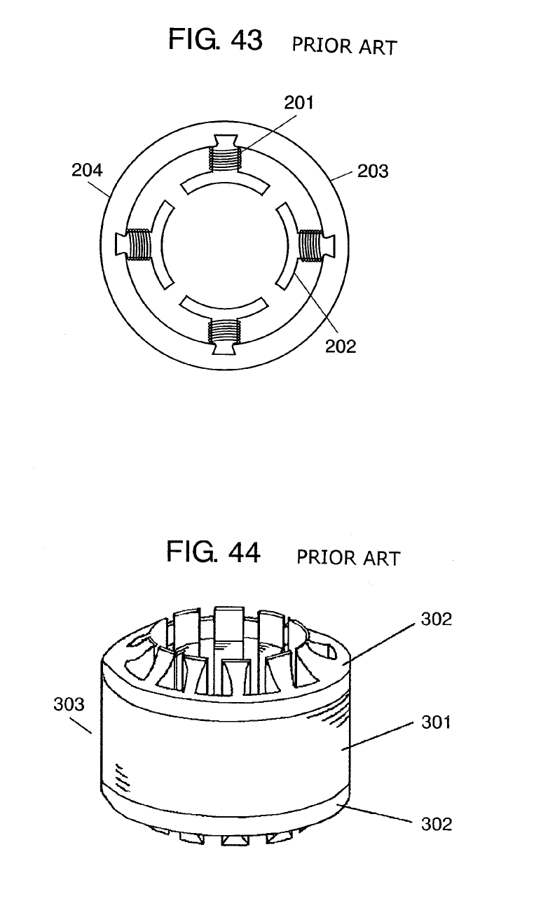

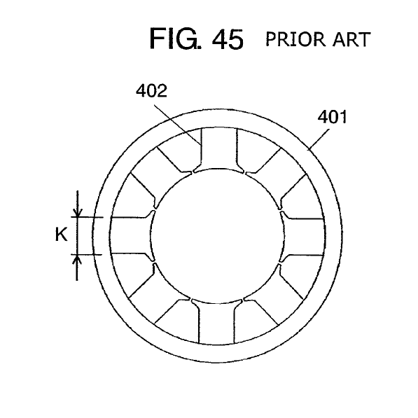

The stator iron core in accordance with the seventh embodiment employs four slots; however, the advantages of the present invention is not limited by the number of slots, and the preceding structures are applicable not only to the capacitor motor but also to other motors which employ a concentrated winding. The protrusions for receiving fastening members are provided on the outer walls of cup-like members 70A, 70B at two places; however, the number of the protrusions is not limited to this instance. FIG. 41 shows another instance where protrusions for receiving fastening members are provided at four places.

### Embodiment 8

FIG. 42 shows a capacitor motor in accordance with the eighth embodiment, this capacitor motor differs from that of the seventh embodiment in the following point: An average wall thickness of ring-shaped sections 76A, 76B is set equal to the radial average wall thickness of second divided iron-core units 56A, 56B. As discussed in the preceding seventh embodiment, ring-shaped sections 76A, 76B are parts of the cup-shaped housing of the motor, and solid with (continued to) second divided iron-core units 56A, 56B which form cup-like members 70A, 70B formed of dust core which is made by molding magnetic powder into the given shape. The structural elements in FIG. 42 similar to those shown in FIG. 30-FIG. 41 have the same reference marks, and the descriptions thereof are omitted here.

The foregoing structure, i.e. ring-shaped sections 76A, 76B have the average wall thickness equal to that of iron-core units 56A, 56B in radius direction, allows increasing the sectional area of second divided iron-core units 56A, 56B which form magnetic paths at the outer circumference of first divided iron-core units 54, so that both of the sectional area of the magnetic path and the total number of magnetic fluxes can be increased or the magnetic flux density can be lowered. As a result, the motor can increase its efficiency.

In the seventh and eighth embodiments, any part of cup-like members 70A, 70B forming the motor housing can be used as a magnetic path depending on the dimensions specified to the stator iron core.

### INDUSTRIAL APPLICABILITY

A capacitor motor of the present invention allows improving motor efficiency and assembling accuracy, and it also facilitates and streamlines the assembly of the motors. The capacitor motor can be used for air blowers employed in small-size household electrical appliances such as electrical fans and ventilation fans.

1. A capacitor motor comprising;
a stator including an stator iron core and a winding; and
a rotor including a rotor iron core,
wherein the stator iron core comprises:
a plurality of first divided iron-core units having tooth sections; and
a second divided iron-core unit forming a magnetic path of the first divided iron-core units,
wherein the windings are wound on the tooth sections, and accommodated in a plurality of slots formed by the first divided iron-core units and the second divided iron-core unit,
wherein the first divided iron-core units are formed by punching electromagnetic steel plates and layering the electromagnetic steel plates punched out,
wherein the second divided iron-core unit is formed by molding magnetic powder into a given shape, and
wherein the first divided iron-core units and the second divided iron-core unit are jointed together by a given means such that the tooth sections can be arranged radially at the outer circumference of the rotor iron core.

2. The capacitor motor of claim 1, wherein the given means includes at least one of bonding, welding, and mechanical assembly.

3. The capacitor motor of claim 1, wherein an axial length of the second divided iron-core unit is longer than an axial length of a section where the winding is mounted on the tooth section.

4. The capacitor motor of claim 1, wherein the first divided iron-core units further include a third divided iron-core unit, and a sectional area of the magnetic path is set greater than a sectional area of the section where the winding is mounted on the tooth section.

5. The capacitor motor of claim 4, wherein an axial length of the third divided iron-core unit is equal to an axial length of the rotor iron core.

6. The capacitor motor of claim 1, wherein the tooth section has a face confronting the rotor, and an axial length of the confronting face is equal to an axial length of the rotor iron core.

7. The capacitor motor of claim 1, wherein the first divided iron-core units are formed of four pieces, and the windings are mounted to the tooth sections in a concentrated winding manner.

8. The capacitor motor of claim 1, wherein a recess and a projection are provided to a tip of outer wall of the first divided iron-core units and an inner wall of the second divided iron-core unit respectively.

9. The capacitor motor of claim 1, wherein the second divided iron-core unit is split into two pieces in a direction at right angles to an axial direction, and has a plurality of mounting sections in a circumference direction, wherein tips of an outer wall of the first divided iron-core units are sandwiched by the mounting sections.

10. The capacitor motor of claim 9, wherein the second divided iron-core unit is further split into a plurality of pieces in the circumference direction, wherein the tips of the outer wall are rigidly mounted to the mounting sections by one of bonding and welding.

11. The capacitor motor of claim 1, wherein the second divided iron-core unit is split into a plurality of pieces in a circumference direction, and the given means employs mechanical assembly together with one of bonding and welding.

12. The capacitor motor of claim 1 further comprising a cup-like member forming a housing of the motor, wherein the second divided iron-core unit is unitarily formed with the cup-like member.

13. The capacitor motor of claim 12, wherein the cup-like member includes:
the second divided iron-core unit forming a ring-shaped lateral face of the housing;
a ring-shaped section being solid from the second divided iron-core unit and being provided to an outer face of the windings; and
a lid section having a bearing holder at its center.

14. The capacitor motor of claim 13, wherein an average wall thickness of the ring-shaped section and that of the lid section are set thinner than a radial thickness of the second divided iron-core unit.

15. The capacitor motor of claim 12, wherein both of the cup-like member and the second iron-core unit are split into two pieces respectively.

16. The capacitor motor of claim 15, wherein the second divided iron-core unit has a plurality of mounting sections at its inner wall, and tips of outer walls of the first divided iron-core units are sandwiched by the mounting sections.

17. The capacitor motor of claim 15, wherein the second iron-core unit has a plurality of protrusions at its outer wall for receiving fastening members.

18. The capacitor motor of claim 13, wherein an average of wall thickness of the ring-shaped section is set equal to a radial thickness of the second divided iron-core unit.

19. A method of manufacturing a capacitor motor which comprises a stator including a stator iron core with a winding and a rotor including a rotor iron core,
wherein the stator iron core comprises a plurality of first divided iron-core units having tooth sections, and a second divided iron-core unit forming a magnetic path of the first divided iron-core units,
the method comprising the steps of:
(a) forming the first divided iron-core units by punching electromagnetic steel plates and layering the electromagnetic steel plates punched out,
(b) forming the second divided iron-core unit by molding magnetic powder into a given shape;
(c) mounting the windings on the tooth sections;
(d) coupling a plurality of the first divided iron-core units together radially, on which the windings are mounted, on inner wall of the second divided iron-core unit by a given means; and
(e) inserting the rotor iron core to inside of the first divided iron-core units along inner wall of the first divided iron-core units.

20. The manufacturing method of claim 19, wherein an axial length of the second divided iron-core unit is set longer than an axial length of the first divided iron-core units.

21. The manufacturing method of claim 19, wherein a recess and a projection are provided to a tip of outer wall of the first divided iron-core unit and the inner wall of the second divided iron-core unit respectively, wherein the step (d) includes the step of mating the recesses with the projections respectively.

22. The manufacturing method of claim 19, wherein the second divided iron-core unit is split into two pieces in a direction at right angles to an axis thereof, and has a plurality of mounting sections along a circumference direction, wherein the step (d) includes the step of sandwiching tips of outer wall of the first divided iron-core units with the mounting sections.

23. The manufacturing method of claim 19, wherein the second divided iron-core unit is further divided into a plurality of pieces along the circumference direction, wherein the step (d) includes the step of bonding or welding the tips of the outer wall and the mounting sections together.

24. The manufacturing method of claim 23, wherein the second divided iron-core unit has a recess corresponding to the outer wall of the first divided iron-core units, wherein the step (d) includes the step of mating the first divided iron-core unit with the recess.
